(19) United States
(12) Patent Application Publication
(10) Pub. No.: US 2011/0006107 A1
(43) Pub. Date: Jan. 13, 2011

(54) CARTON WITH A SET OF DIFFERENT CONTAINERS

(75) Inventors: Bodo Werner Lutzig, Chavornay (CH); Koko Ozono, Tokyo (JP)

Correspondence Address: BUCHANAN, INGERSOLL & ROONEY PC, POST OFFICE BOX 1404, ALEXANDRIA, VA, 22313-1404, US

(73) Assignee: Philip Morris USA Inc., Richmond, VA (US)

(21) Appl. No.: 12/832,696

(22) Filed: Jul. 8, 2010

(30) Foreign Application Priority Data
Jul. 8, 2009 (EP) 09164846.9

(51) Int. Cl. B65D 5/42; B31B 1/14

(52) U.S. Cl. 229/120.01; 493/56

(57) ABSTRACT

A carton contains a number of containers, each container including a lid, a box, and an inner frame attached to the box. Each inner frame has a front wall and two side walls with each front wall of an inner frame having a cut-out portion and an extension portion, wherein the shape of the cut-out and extension portion is different for at least two of the containers within the carton.

### CROSS REFERENCE TO RELATED APPLICATION

This application claims priority to EP09164846.9, filed Jul. 8, 2009, the entire content of which is incorporated herein by this reference thereto.

### Working Environment

The present invention relates to a carton containing a number of different containers and a method for producing a plurality of individual inner frames from a blank. The method may be used for producing a sequence of containers that are different from each other.

Hinge lid containers are used in many fields of application. In particular hinge lid containers are well adapted for consumer goods, such as for example smoking articles. For shipping and distribution to the consumers the hinge lid packs are assembled and packed in cartons, with each such carton containing a predetermined number of such hinge lid containers, for example ten such hinge lid containers.

A hinge lid container includes a box and a lid hingedly attached to the box. A so called “inner frame” is attached to the inside of the front wall of the box and reaches into the lid of the container when the container is closed. An inner frame of this type usually includes a front wall and two side walls. The front wall of the inner frame is provided with a cut-out portion at the upper part of the inner frame and an extension portion at the lower part of the inner frame. The cut-out portion of the inner frame facilitates access to the consumer goods contained in the box.

In production, the inner frame is cut upon demand from a blank that is provided from a reel. Cutting the individual inner frames from the continuous material provided from the reel is performed without the creation of waste, that is, the shape of the cut-out section of one specific inner frame corresponds to the extension portion of the adjacent inner frame. These cut-out portions and extension portions can be cut using a rotating wheel having several blades attached to the rotating wheel or can be cut using a die-cutting tool.

However, there is a need for providing hinge lid containers with increased attractiveness to consumers while substantially maintaining the production cost of the containers.

### SUMMARY

A carton containing a number of containers is provided. In a preferred embodiment, each container includes a lid, a box, and an inner frame attached to the box. Preferably, each inner frame has a front wall and two side walls with each front wall of an inner frame having a cut-out portion and an extension portion. Also preferably, the shape of the cut-out and extension portion is different for at least two of the containers. In the preferred embodiment, the shape of the cut-out portion of each of the inner frames of the containers contained within the same carton is different from the shape of the cut-out portion of the inner frames of all other containers contained in the same carton. Preferably, each of the inner frames includes a printing area arranged between its cut-out portion and its extension portion. Also preferably, the individual inner frames include cut-out and extension portions which have a non-interlocking shape.

In another embodiment, a method for producing a plurality of individual inner frames from a blank is provided. Preferably, the method includes the steps of: cutting individual inner frames each having a front wall and two side walls from the blank such that each front wall of an inner frame has a cut-out portion and an extension portion, with the extension portions and the cut-out portions of adjacent inner frames mating with one another. Also preferably, cutting the individual inner frames is performed such that a plurality of inner frames with at least two different shapes of cut-out portions and extension portions are produced from one blank. Moreover, the step of cutting individual inner frames includes sequentially cutting a plurality of series of inner frames from the blank. Preferably, each series includes the same predetermined sequence of inner frames wherein the inner frames within the sequence have at least two different shapes of cut-out portions and extension portions.

In the preferred embodiment, cutting the inner frames of the predetermined sequence of one series is performed such that each individual inner frame of the predetermined sequence has a shape of its cut-out portion and extension portion which is different from the shape of the rest of the inner frames of the same sequence. Preferably, the method further includes the step of providing a cutting means, wherein the cutting means includes a number of cutting blades, wherein the shape of a cutting blade determines the shape of the cut-out portion of a first inner frame of the predetermined sequence and the shape of an extension portion of a second inner frame of the predetermined sequence, and wherein at least two of the cutting blades of the cutting means are different from each other. Moreover, cutting of the individual inner frames includes cutting individual inner frames such that the cut-out portions and extension portions of the inner frames have a non-interlocking shape.

### BRIEF DESCRIPTION OF THE DRAWINGS

The invention will be further described, by way of example only, with reference to the accompanying drawings, in which:

FIG. 1 shows a prior art hinge lid container including an inner frame attached to the inner surface of the front wall of the box of the container.

FIG. 2 shows a top view on an embodiment of a sequence of inner frames, wherein all inner frames of the sequence having a different shape.

FIG. 3 shows a hinge lid container including a lid, a box, and an inner frame attached to the box

FIG. 4 shows a carton including a number of containers.

### DETAILED DESCRIPTION

In a preferred embodiment, a carton according to the present invention includes a number of containers. In the preferred embodiment, each container includes a lid, a box, and an inner frame attached to the box. Preferably, each inner frame has a front wall and two side walls, and each front wall of an inner frame has a cut-out portion and an extension portion. Also preferably, the shape of the cut-out and extension portion is different for at least two of the containers. Moreover, the shape of the cut-out and extension portion can be different for more than two of the containers contained in such carton. This way, every time a new container from the carton is opened, the consumer may be surprised by the individual character of the differently shaped inner frame.

In the high speed production of cartons on prior art packaging machinery, the cartons are automatically assembled around sequentially produced hinge lid containers. According to the invention, the hinge lid containers with different inner frames are produced sequentially, as will be described in more detail below. This allows manufacturing cartons on prior art machinery at high speed with only minor modifications.

The terms “front”, “back”, “upper”, “lower”, “side”, “top”, “bottom” and other terms used to describe relative positions of the components of containers refer to the container in an upright position with the lid at the top end and the hinge on the back. When the container in the upright position is open, the consumer articles contained in the box may be removed from the upper end of the container.

Preferably, each of the inner frames includes a printing area arranged between its cut-out portion and its extension portion. Such a printing area may be used for example to enhance the different design of the containers contained in the same carton. For example, individual messages with consumer information may be printed onto the printing area. The individual message may be determined or randomly picked from a dataset of individual messages.

Preferably, in the carton the individual inner frames include cut-out and extension portions which have a non-interlocking shape. The term “non-interlocking” is used throughout the specification to indicate that adjacent extension and cut-out portions have a shape such that the respective adjacent inner frames can be easily separated from one another by pulling them apart in the direction of the longitudinal extension of the strip from which they are cut to size. In other words, the adjacent cut-out and extension portions do not have any form-locking parts whereas “interlocking parts” would require that adjacent inner frames must be lifted or lowered relative to one another in order to allow them to get separated.

The invention is also directed to a method for producing a plurality of individual inner frames from a blank. In a preferred embodiment, the method includes the steps of: cutting individual inner frames each having a front wall and two side walls from the blank such that each front wall of an inner frame has a cut-out portion and an extension portion, with the extension portions and the cut-out portions of adjacent inner frames mating with one another. Preferably, cutting the individual inner frames is performed such that a plurality of inner frames with at least two different shapes of cut-out portions and extension portions are produced from one blank. Also preferably, the step of cutting individual inner frames includes sequentially cutting a plurality of series of inner frames from the blank, each series including the same predetermined sequence of inner frames wherein the inner frames within the sequence have at least two different shapes of cut-out portions and extension portions.

In the preferred embodiment, the containers with different inner frames are produced sequentially. Thus, a carton may be assembled around a given number of sequentially produced containers on known packaging machinery in order to produce a carton.

Preferably, the step of cutting the inner frames of the predetermined sequence of one series is performed such that each individual inner frame of the predetermined sequence has a shape of its cut-out portion and extension portion which is different from the shape of the rest of the inner frames of the same sequence. Accordingly, each inner frame of one sequence has a unique shape within one sequence, thus maximizing the number of different shapes of the inner frames within one series.

Preferably, the method also includes the step of providing a cutting means. In the preferred embodiment, the cutting means includes a number of cutting blades. Preferably, the shape of a cutting blade determines the shape of the cut-out portion of a first inner frame of the predetermined sequence and the shape of an extension portion of a second inner frame of the predetermined sequence. Also preferably, at least two of the cutting blades of the cutting means are different from each other. Moreover, the cutting means is a rotary cutting means. Alternatively, a planar die cutting means may be used.

Preferably, the step of cutting of the individual inner frames includes cutting individual inner frames. Also preferably, the cut-out portions and extension portions of the inner frames have a non-interlocking shape.

Containers according to the invention may be in the shape of a generally rectangular parallelepiped, with right-angled longitudinal and right-angled transverse edges. The term “longitudinal” refers to a direction from bottom to top of the container or vice versa. In the blank of the inner frames, the term “longitudinal” refers to a direction parallel to the outer edges of the side walls of the inner frame. The term “transverse” refers to a direction perpendicular to the longitudinal direction.

Alternatively, the container may include one or more generally rounded longitudinal edges, generally rounded transverse edges, generally bevelled longitudinal edges or generally bevelled transverse edges, or combinations thereof. For example, the container may include, without limitation: one or two generally longitudinal rounded or bevelled edges on the front wall, and/or one or two generally longitudinal rounded or bevelled edges on the back wall. Alternatively, the container may include, without limitation: one or two transverse generally rounded or generally bevelled edges on the front wall, and/or one or two transverse generally rounded or generally bevelled edges on the back wall. In another embodiment, the container may include, without limitation, one longitudinal generally rounded edge and one longitudinal generally bevelled edge on the front wall, and/or one transverse generally rounded edge and one transverse generally bevelled edge on the back wall.

In yet another embodiment, the container may include, without limitation, one or two transverse generally rounded or generally bevelled edges on the front wall and one or two longitudinal generally rounded or generally bevelled edges on the front wall. In still another embodiment, the container may include, without limitation, two longitudinal generally rounded or generally bevelled edges on a first side wall or two transverse generally rounded or generally bevelled edges on the second side wall.

Where the container includes one or more generally rounded edges and is made from a laminar blank, preferably the blank includes three, four, five, six or seven scoring lines or creasing lines to form the generally rounded edge in the assembled container. The scoring lines or creasing lines may be either on the inside of the container or on the outside of the container. Preferably, the scoring lines or creasing lines are spaced apart from each other a distance ranging from about 0.3 mm to 4 mm.

Preferably, the spacing of the creasing lines or scoring lines is in function of the thickness of the laminar blank. Preferably, the spacing between the creasing lines or scoring lines ranges from about 0.5 to about 4 times larger than the thickness of the laminar blank.

Where the container comprises one or more generally bevelled edges, preferably the bevelled edges have a width ranging from about 1 mm to about 10 mm, preferably ranging from about 2 mm to about 6 mm. Alternatively, the container may comprise a double bevel formed by three parallel creasing lines or scoring lines that are spaced apart such that two distinct bevels form on the edge of the container.

Alternatively to a container with a generally rectangular transverse cross section, the container may have a for example a generally polygonal cross section such as triangular, quadrangular or hexagonal, or a cross section which is oval, semi-oval, circular or semi-circular.

Where the container comprises a generally bevelled edge and is made from a laminar blank, the bevel may be formed by two parallel creasing lines or scoring lines in the laminar blank. The creasing lines or scoring lines may be arranged symmetrically to the edge between a first wall and a second wall. Alternatively, the creasing lines or scoring lines may be arranged asymmetrically to the edge between the first wall and the second wall, such that the bevel extends further into the first wall of the container than into the second wall of the container.

In the preferred embodiment, the container may be formed from any suitable materials including, but not limited to, cardboard, paperboard, plastic, metal, or combinations thereof. Preferably, the cardboard has a weight ranging from about 100 grams per square meter (gsm) to about 350 gsm.

In the preferred embodiment, containers may be used as packages for a variety of consumer goods. In particularly preferred embodiments, containers are used to package smoking articles. Containers may be advantageously used to package smoking articles including, but not limited to, known lit-end cigarettes, cigars or cigarillos, heated smoking articles comprising a combustible fuel element or heat source and an aerosol-generating substrate (for example cigarettes of the type disclosed in U.S. Pat. No. 4,714,082) and smoking articles for use with electrical smoking systems (for example cigarettes of the type disclosed in U.S. Pat. No. 5,692,525).

Through an appropriate choice of the dimensions thereof, containers may be designed to hold different total numbers of smoking articles, or different arrangements of smoking articles. For example, through an appropriate choice of the dimensions thereof, containers may be designed to hold a total of about ten to about thirty smoking articles.

In the preferred embodiment, containers may hold one, two, three four or five separate bundles of consumer goods. Preferably, the separate bundles may be arranged substantially parallel to the front wall and to the back wall or substantially perpendicular to the front wall and to the back wall.

Within a bundle, the smoking articles may be arranged in different collations, depending on the total number of smoking articles, the dimensions of the smoking articles or the cross sectional shape of the container. For example, the smoking articles may be arranged in a bundle in a single row of five, six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five, six, seven, eight, nine, or ten; or four rows of four, five, six or seven. Alternatively, the two or more rows may include at least two rows containing different numbers of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

In the preferred embodiment, containers may hold smoking articles of the same type or brand, or of different types or brands. In addition, both filterless smoking articles and smoking articles with various filter tips may be contained, as well as smoking articles of differing length (for example, ranging from about 40 mm to about 180 mm), diameter (for example, ranging from about 4 mm to about 9 mm). In addition, the smoking articles may differ in strength of taste, resistance to draw and total particulate matter delivery. When the container comprises more than one bundle, each bundle within the same container may hold the same or different types of smoking articles as listed above.

Preferably, the dimensions of the container are adapted to the length of the smoking articles, and the collation of the smoking articles. Typically, the outer dimensions of the container range from about 0.5 mm to about 5 mm larger than the dimensions of the bundle of smoking articles housed inside the container.

Preferably, containers according to the invention have a height ranging from about 60 mm to about 150 mm, and more preferably a height ranging from about 70 mm to about 125 mm. Also preferably, the height is measured from the top wall to the bottom wall of the container.

Preferably, containers have a width ranging from about 12 mm to about 150 mm, and more preferably a width ranging from about 70 mm to about 125 mm. The width is measured from the first side wall to the second side wall of the container.

Preferably, containers have a depth ranging from about 6 mm to about 100 mm, and more preferably a depth ranging from about 12 mm to about 25 mm. Also preferably, the depth is measured from the front wall to the back wall of the container (comprising the hinge between box and lid).

Preferably, the ratio of the height of the container to the depth of the container ranges from about 0.3 to 1 to about 10 to 1, more preferably ranges from about 2 to 1 to about 8 to 1, and most preferably ranges from about 3 to 1 to about 5 to 1

Preferably, the ratio of the width of the container to the depth of the container ranges from about 1 to 1 to about 10 to 1, more preferably ranges from about 2 to 1 to about 8 to 1, and most preferably ranges from about 2 to 1 to about 3 to 1.

Preferably, the ratio of the height of the lid back wall to the height of the box back wall ranges from about 0 to 1 (hinge located at the top edge of the container) to about 1 to 1, more preferably, ranges from about 1 to 5 to about 1 to 10, and most preferably, ranges from about 1 to 6 to about 1 to 8.

Preferably, the ratio of the height of the lid front wall to the height of the box front wall is between about 1 to 0 (lid covering the entire front wall) to about 1 to 10, more preferably, between about 1 to 1 and about 1 to 5, most preferably, between about 1 to 2 and about 1 to 3.

In the preferred embodiment, the exterior surfaces of containers may be printed, embossed, debossed or otherwise embellished with manufacturer or brand logos, trade marks, slogans and other consumer information and indicia. Alternatively, or in addition, the exterior surfaces of containers may be at least partially covered with lacquer, metallization, holograms, luminescent material, or any other materials that alter the feel, odor or appearance of the container.

Where the inner housing of a container contains one or more bundles of smoking articles, the smoking articles are preferably wrapped in an inner liner of, for example, metal foil or metallised paper.

Where the container includes smoking articles, the container may also include waste-compartments (for example for ash or butts) or other consumer goods, for example matches, lighters, extinguishing means, breath-fresheners or electronics. The other consumer goods may be attached to the outside of the container, contained within the container along with the smoking articles, in a separate compartment of the container or combinations thereof.

Preferably, the outer wrapper is a transparent polymeric film of, for example, high or low density polyethylene, polypropylene, oriented polypropylene, polyvinylidene chloride, cellulose film, or combinations thereof.

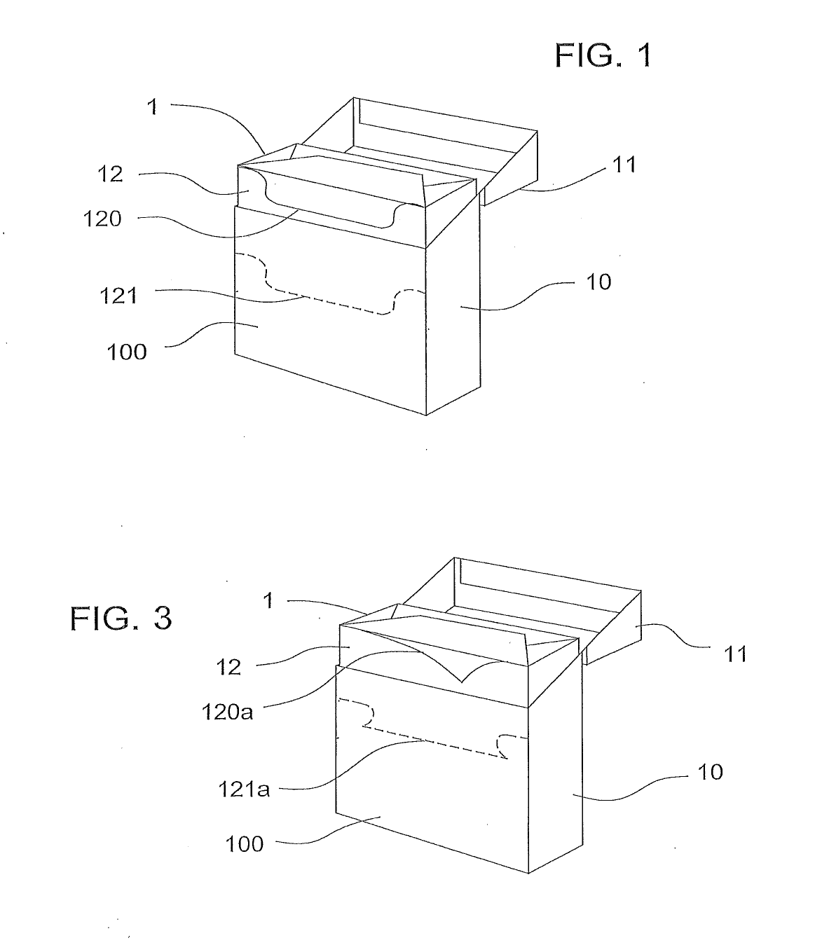

As shown in FIG. 1, a hinge lid container 1 includes a box 10 and a lid 11, as well as an inner frame 12. A wrapped bundle of smoking articles is arranged within the container 1. Inner frame 12 includes a cut-out portion 120 and an extension portion 121 (delimited by a dashed line) which is attached to the inner surface of the front wall 100 of the box 10 and projects upwardly from the box 10.

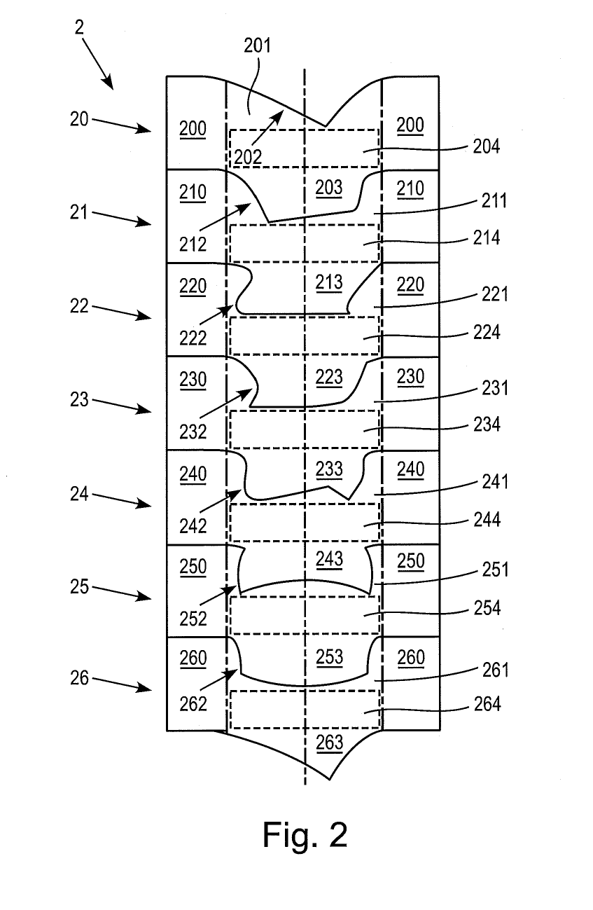

As already mentioned, preferably, the inner frames are produced separately and are attached to the inner surface of the front wall of the box. As shown in FIG. 2, in a preferred embodiment, a sequence 2 of seven inner frames 20, 21, 22, 23, 24, 25 and 26, may constitute a sequence that can be cut from a continuous strip (blank) provided from a reel (not shown). Each inner frame 20, 21, 22, 23, 24, 25, 26 is delimited by a cut line, shown as continuous line in FIG. 2. As can be seen in FIG. 2, each of the inner frames 20, 21, 22, 23, 24, 25, 26 has a different shape. Preferably, inner frame 20 includes two side walls 200 and a front wall 201. Also preferably, the dashed lines between the side walls 200 and the front wall 201 indicate the folding lines of inner frame 20. In the preferred embodiment, front wall 201 has a cut-out portion 202 which has a generally triangular shape. Moreover, front wall 201 can include an extension portion 203, the shape of which corresponds to the shape of cut-out portion 212 of the adjacent inner frame 21. Preferably, inner frame 21 also includes two side walls 210, a front wall 211 having the afore-mentioned cut-out portion 212 and an extension portion 213 the shape of which corresponds to the shape of cut-out portion 222 of the adjacent inner frame 22. Also preferably, inner frame 22 includes two side walls 220, a front wall 221 having the cut-out portion 222 and an extension portion 223 the shape of which corresponds to the shape of cut-out portion 232 of inner frame 23, and which has two side walls 230 and a front wall 231 having the cut-out portion 232 and an extension portion 233, the shape of which corresponds to the shape of cut-out portion 242 of the adjacent inner frame 24. Preferably, inner frame 24 has two side walls 240 and a front wall 241 which has the afore-mentioned cut-out portion 242 and an extension portion 243, the shape of which corresponds to the shape of the cut-out portion 252 of the adjacent inner frame 25, which has two side walls 250, a front wall 251 having the cut-out portion 252 and an extension portion 253 the shape of which corresponds to the shape of the cut-out portion 262 of the adjacent inner frame 26. Moreover, inner frame 26 has two side walls 260 and a front wall 261 having the cut-out portion 262 and an extension portion 263 the shape of which corresponds to the shape of the adjacent inner frame (not shown in FIG. 2) the cut-out portion of which has a shape similar to that of inner frame 20, since the sequence 2 shown in FIG. 2 then starts anew.

As shown in FIG. 3, in an alternative embodiment, a hinge lid container 1 includes a box 10 and a lid 11, as well as an inner frame 12. A wrapped bundle of smoking articles is arranged within the container 1. Inner frame 12 includes a cut-out portion 120a and an extension portion 121a (delimited by a dashed line) which is attached to the inner surface of the front wall 100 of the box 10 and projects upwardly from the box 10. The shape of the shape of the cut-out portion 120a of each of the inner frame 12 can be different from the shape of the cut-out portion of the inner frames of all other containers contained in the same carton. By cutting the individual inner frames from the continuous material provided from the reel as described herein, waste is reduced, and hinge lid containers are formed wherein the shape of the cut-out section of one specific inner frame corresponds to the extension portion of the adjacent inner frame.

While a sequence of seven different inner frames has been shown by way of example, any other number of different frames is also possible within one sequence and is deemed to be within the spirit of the present invention. However, by way of example a range of seven to twenty different shapes may be a reasonable number of different shapes of frames within one sequence. Particularly preferred is a number of ten, matching the number of containers in a carton.

As can also be seen in FIG. 2, the cut-out portion 202 of inner frame 20, the extension portion 203 and the corresponding cut-out portion 212, the extension portion 253 and the corresponding cut-out portion 262, the extension portion 263 and the corresponding cut-out portion of the adjacent inner frame (not shown) corresponding to the shape of cut-out portion 202 of inner frame 20 all have a non-interlocking shape. This means that these inner frames can be separated from one another by simply pulling them apart in the longitudinal direction of the strip after cutting of the individual inner frames.

As can further be seen in FIG. 2, the extension portion 223 of inner frame 22 and the corresponding cut-out portion 232 of the adjacent inner frame 23, the extension portion 233 of inner frame 23 and the corresponding cut-out 242 portion of inner frame 24, the extension portion 243 and the corresponding cut-out portion of inner frame 25 all have an interlocking shape. This means, that these inner frames cannot be separated from one another by simply pulling them apart in the longitudinal direction of the strip after cutting of the individual inner frames. Instead, they must be lifted/lowered relative to one another so as to separate them due to their form-locking shape.

While a sequence of inner frames including inner frames having a non-interlocking shape and inner frames having an interlocking shape are shown in FIG. 2, it is also possible to produce only one type of shape (non-interlocking or interlocking) of the inner frames, preferably inner frames having a non-interlocking shape which can be easily separated from one another in the manner described above.

Moreover, as can be seen in FIG. 2 the inner frames 20, 21, 22, 23, 24, 25, 26 may comprise a printing area 214, 224, 234, 244, 254, 264, respectively. This printing area usually is visible when the inner frame has been attached to the box, regardless to the shape of the inner frame. The printing area may serve to apply prints further enhancing the attractiveness of the box or may serve to print registration information thereon.

As already mentioned, the cutting may be performed in a conventional manner, for example with the aid of a cutting wheel to which the respective number of blades are attached in the desired sequence (for the embodiment shown in FIG. 2 seven different cutting blades can be attached to the rotating cutting wheel in the desired sequence). Alternatively, a die-cutting process can be used to cut the individual inner frames to size.

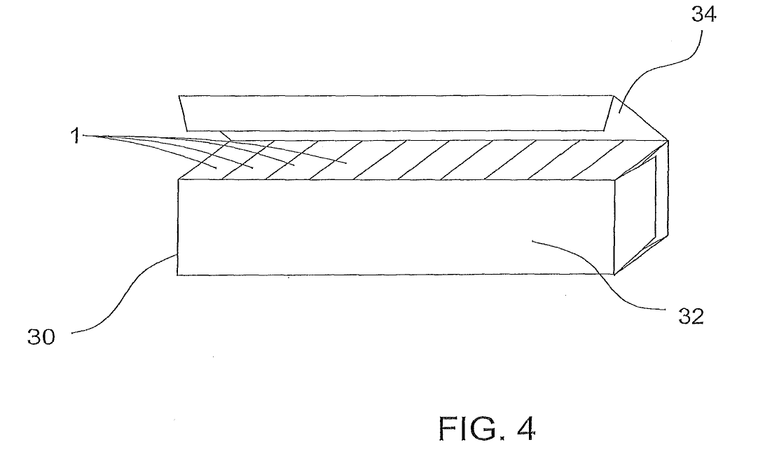

As shown in FIG. 4, a carton 30 includes a lid 34 and at least one sidewall 32. The carton 30 contains multiple hinge lid containers 1 as described herein.

While embodiments of the invention have been described with the aid of the drawings, the invention is not limited to the described embodiments but rather numerous variations are conceivable without departing from the spirit of the present invention.

In this specification, the word “about” is often used in connection with numerical values to indicate that mathematical precision of such values is not intended. Accordingly, it is intended that where “about” is used with a numerical value, a tolerance of ±10% is contemplated for that numerical value.

In this specification the words “generally” and “substantially” are sometimes used with respect to terms. When used with geometric terms, the words “generally” and “substantially” are intended to encompass not only features which meet the strict definitions but also features which fairly approximate the strict definitions.

While the foregoing describes in detail a preferred carton with a set of different containers with reference to a specific embodiment thereof, it will be apparent to one skilled in the art that various changes and modifications may be made to the carton, which do not materially depart from the spirit and scope of the foregoing description. Accordingly, all such changes, modifications, and equivalents that fall within the spirit and scope of the appended claims are intended to be encompassed thereby.

We claim:

1. A carton containing a number of containers, each container comprising a lid, a box, and an inner frame attached to the box, each inner frame having a front wall and two side walls with each front wall of an inner frame having a cut-out portion and an extension portion, wherein the shape of the cut-out and extension portion is different for at least two of the containers.

2. The carton of claim 1, wherein the shape of the cut-out portion of each of the inner frames of the containers contained within the same carton is different from the shape of the cut-out portion of the inner frames of all other containers contained in the same carton.

3. The carton of claim 1, wherein each of the inner frames includes a printing area arranged between its cut-out portion and its extension portion.

4. The carton of claim 1, wherein the individual inner frames include cut-out and extension portions which have a non-interlocking shape.

5. A method for producing a plurality of individual inner frames from a blank, the method comprising the steps of:
cutting individual inner frames each having a front wall and two side walls from the blank such that each front wall of an inner frame has a cut-out portion and an extension portion, with the extension portions and the cut-out portions of adjacent inner frames mating with one another,
wherein cutting the individual inner frames is performed such that a plurality of inner frames with at least two different shapes of cut-out portions and extension portions are produced from one blank.

6. The method of claim 5, wherein the step of cutting individual inner frames comprises sequentially cutting a plurality of series of inner frames from the blank, each series including the same predetermined sequence of inner frames wherein the inner frames within the sequence have at least two different shapes of cut-out portions and extension portions.

7. The method of claim 6, wherein cutting the inner frames of the predetermined sequence of one series is performed such that each individual inner frame of the predetermined sequence has a shape of its cut-out portion and extension portion which is different from the shape of the rest of the inner frames of the same sequence.

8. The method of claim 6, wherein the method further includes the step of providing a cutting means, wherein the cutting means includes a number of cutting blades, wherein the shape of a cutting blade determines the shape of the cut-out portion of a first inner frame of the predetermined sequence and the shape of an extension portion of a second inner frame of the predetermined sequence, and wherein at least two of the cutting blades of the cutting means are different from each other.

9. The method of claim 5, wherein cutting of the individual inner frames comprises cutting individual inner frames such that the cut-out portions and extension portions of the inner frames have a non-interlocking shape.
